(19) United States
(12) Patent Application Publication
(10) Pub. No.: US 2010/0172129 A1
(43) Pub. Date: Jul. 8, 2010

(54) ILLUMINATING DEVICE FOR LIGHT STEEL FRAME

(76) Inventor: CHEN HUANG HSIEH, KEELUNG CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/652,225

(22) Filed: Jan. 5, 2010

(30) Foreign Application Priority Data
Jan. 8, 2009 (TW) 098200291

(51) Int. Cl. F21V 7/00

(52) U.S. Cl. 362/217.05

(57) ABSTRACT

An illuminating device is mounted on top of or below a light steel frame and includes at least one one-piece elongated shade in which a bowl-shaped mirror reflector is mounted. A fluorescent tube is mounted in the shade and longer than one of a plurality of sections of the light steel frame. A wing extends horizontally from each of two lateral sides of the shade. An extrusion ridge is formed on a top side of the shade. Two shield boards are mounted in each section of the light steel frame extended across by the shade. An edge of each shield board rests on one of the wings. First and second snap fasteners are selectively engaged with the extrusion ridge. The first snap fastener can fix an electronic stabilizer on the extrusion ridge. The second snap fastener can fix the illuminating device to a longitudinal beam of the light steel frame.

### BACKGROUND OF THE INVENTION

The present invention relates to an illuminating device and, more particularly, to an illuminating device mounted on a light steel frame, providing anti-dust function, increasing brightness, saving electricity, allowing easy and rapid installation, and providing even brightness.

Although fluorescent tubes have been significantly improved in lumen efficiency, service life, color rendering, and color temperature diversity, several general rules still apply. Namely, a thinner fluorescent tube is the brighter than a wider one; a straighter fluorescent tube is brighter than a curved one; and a longer fluorescent tube has higher efficiency and a longer service life. As an example, the brightness of a T8/40 W fluorescent tube is equal to that of three T8/20 W fluorescent tubes and has a service life two times of that of the T8/20 W fluorescent tubes. As another example, the brightness of a T5/28 W fluorescent tube is equal to that of a T8/40 W fluorescent tube and saves 30% of electricity and has a service life two times of that of the T8/40 W fluorescent tube.

In currently available illuminating devices for light weight frames, insert type light boxes are mounted to a grid type light steel frame of a ceiling and spaced from each other. With reference to FIG. 1, each insert type light box 1a has an area the same as one of a plurality of sections of the light steel frame 2a and is mounted above and concealed by the light steel frame 2a, such that the light box 1a and the light steel frame 2a provide a smooth appearance.

Each light box 1a has a size of 1.2 m×1.2 m or 1.2 m×2.4 m corresponding to the size of each section (1.2 m×1.2 m) of the light steel frame 2a. Furthermore, each light box la includes two to four fluorescent tubes 3a (such as T5, T8, or PL type fluorescent tubes). In a case that each light box 1a includes four T2/20 W fluorescent tubes each having a length of 1.2 meters, the consumed power is 80 W. In addition, the brightness and the illuminating efficiency of the conventional fluorescent tubes 3a are insufficient and unsatisfactory. Furthermore, the light box 1a is bulky, expensive, and consumes considerable energy, such that two adjacent light boxes 1a are generally spaced by two or three sections. The areas below the sections without light boxes 1a are darker, for they can only receive indirect, reflected illumination, leading to insufficient brightness and uneven illumination.

Another type of conventional illuminating device having a single fluorescent tube (such as an inverted triangular light utilized in convenience stores) generally includes a base, a panel, a leg unit, and a starter seat. The base, the panel, the leg unit, and the starter seat are initially separate from each other. In installation, the base is fixed below the light steel frame by screws. After connection of a power cable, the leg unit and the starter seat are mounted to a fixed seat. Light tubes are mounted after mounting the panel. The installation is troublesome and time-consuming. Roof-mounted illuminating devices for light steel frames generally mounted in convenience stores allow continuous installation. However, there are no shields for the light tubes such that the glaring light causes pupil constriction of the customers. As a result, the reflective brightness of the commodities on the display shelves becomes insufficient. Furthermore, the anti-dust effect at the upper portions of the light tubes of the roof-mounted lights and the insert type light boxes are unsatisfactory (dust can cover the upper portions of the light tubes in only months in high dustfall areas), such that the output of the light tubes could be decreased by 50%.

### BRIEF SUMMARY OF THE INVENTION

The present invention is intended to solve the disadvantages of the conventional insert type and roof-mounted illuminating devices by providing a reasonable arrangement of the spatial illumination, simplification of installation, reinforcing the anti-dust effect, increasing the reflective efficiency, and separation design of a stabilizer. The costs of use are cut, the burden to the environment is reduced, the energy efficiency is increased, the service life of the illuminating device is prolonged, and the recycling efficiency is increased, achieving energy saving and carbon reduction as well as green illumination.

According to the preferred teachings of the present invention, a novel illuminating device for a light steel frame provides the reasonable arrangement of the spatial illumination and simplification of installation to overcome the disadvantages (including uneven brightness, short service life of light tubes, low brightness, low lumen efficiency, low illuminating quality, high energy consumption, limitation to installation, and burden to the environment) resulting from installation of illuminating devices of low power light tubes (T8/20 W or T5/14 W) spaced from each other by three or four sections of the light steel frame. The illuminating device according to the preferred teachings of the present invention includes at least one continuous, one-piece, elongated shade extending across two or more sections of the light steel frame. The shade includes two end caps allowing the shade to be mounted on top of the light steel frame. The shade further includes two lateral sides each having a horizontally extending wing. An extrusion ridge is formed on a top side of the shade and includes two lateral walls each having a groove. When the illuminating device is mounted on top of the light steel frame in a concealed manner, the wings of the shade (functioning as inverted T-shaped bracket of a light steel frame) can support shield boards (such as calcium silicate boards) of a certain size for light steel frames, providing even, bright, discontinuous, efficient spatial illumination as well as an aesthetic appearance.

Furthermore, the shade can include a slot in an intermediate portion thereof. When the illuminating device is mounted on top of the light steel frame, the slot receives a transverse beam crossed by the shade so that the shade extends across two sections of the light steel shade. A user of conventional 1.2 m×1.2 m insert type light boxes does not have to alter the original light steel frame while installing the illuminating device according to the preferred teachings of the present invention. Alternatively, the transverse beam can be cut at an intersection with the shade to form a cutout. Thus, the shade does not have to include the slot and can extend across two sections of the light steel shade by directly extending through the cutout.

Two one-piece elongated shades can be connected in series. In a case that a T5/28 W light tube is mounted in each shade, the total power is 56 W, providing even brightness for an area of 4.8 m×4.8 m. T5/54 W light tubes and stabilizers can be utilized for higher brightness. In a 1.2 m×1.2 m area illuminated by conventional insert type light boxes with four T8/20 W light tubes, the total power is 80 W. The area outside the 1.2 m×1.2 m area is darker (the longer distance to the 1.2 m×1.2 m area, the darker). Thus, the brightness provided by the two T5/28 W light tubes is higher than four T8/20 W light tubes while consuming only 70% electricity of that required for four T8/20 W light tubes.

Installation of the illuminating device according to the preferred teachings of the present invention is simplified by utilizing first and second snap fasteners. In a preferred form, when mounting the illuminating device according to the preferred teachings of the present invention below a light steel frame, two second snap fasteners are mounted to a beam of the light steel frame at appropriate positions. The extrusion ridge on the top side of the shade of the illuminating device is engaged in a lower opening of each second snap fastener. The illuminating device according to the preferred teachings of the present invention can, thus, be rapidly mounted below the light steel frame by the second snap fasteners. Removal of the illuminating device can be easily achieved by pressing either side of each second snap fastener.

In another preferred form, when mounting the illuminating device according to the preferred teachings of the present invention on top of the light steel frame, a stabilizer can be fixed at any desired position on the extrusion ridge formed on the top side of the shade by using two first snap fasteners.

With regard to anti-dust effect, since the stabilizer can be fixed at any desired position on the extrusion ridge integrally formed with the shade by the first snap fasteners, neither of the shade and the stabilizer has no holes that are required in conventional designs for fixing purposes. Furthermore, the shade includes a bowl-shaped mirror reflector having a pointed portion, and the light tube is mounted adjacent to the pointed portion. The light tube blocks air currents at two sides of the light tube to avoid flow of dust. The shade includes two ends each having an end cap mounted thereto, such that the shade defines a semi-sealed space having a lower opening. Namely, the shade can shield dust falling from above. Furthermore, since there are no holes in the shade for fixing purposes, convection between the air in the semi-sealed space and the upward air current outside of the shade will not occur when there is no wind, even if the lower opening of the shade is not covered by a transparent cover, preventing dust from entering the semi-sealed space from below. The amount of dust entering the semi-sealed space from below can be reduced even if there is a breeze. Thus, the dustfall on the upper half of the light tube can be significantly reduced, keeping clean and maintaining output of the light tube.

With regard to increase in the reflective efficiency, the light tube is a durable, energy-saving fluorescent tube (such as a T5 fluorescent tube) providing desired brightness. The fluorescent tube is mounted in a position adjacent to the pointed portion of the bowl-shaped mirror reflector of the shade to increase the reflective efficiency. Namely, the light beams emitted from the upper half of the fluorescent tube are reflected by the bowl-shaped mirror reflector out of the lower opening of the shade, increasing the brightness by more than 50%. On the other hand, the fluorescent tube blocks the air currents at the two sides of the fluorescent tube received in the bowl-shaped mirror reflector, further enhancing the anti-dust effect.

When the illuminating devices according to the preferred teachings of the present invention are mounted consecutively to form a long-distance illuminating arrangement, the brightness and the average illuminated area are increased while saving electricity.

Conventionally, the stabilizer is fixed by screws, pop rivets, or rivets to a base of the shade and then covered by a panel. Conventional stabilizers are of coil type and have a service life more than ten years without maintenance. However, electricity-saving, high-efficient, high-frequency electronic stabilizers are the only option for T5 light tubes. The electronic stabilizers have many electronic components and a short service life and operate unstably. Furthermore, electronic stabilizers from various manufacturers are largely varied in specifications, sizes, and prices. Failure of the electronic stabilizers is not uncommon. Repair of such electronic stabilizers fixed by screws, pop rivets, or rivets to the base of the shade is not easy and expensive. To solve these advantages, the present invention utilizes a separate stabilizer that can be utilized with one ore more illuminating devices. The following advantages can be obtained:

1. The size of the illuminating device can be reduced. The illuminating device does not have to include a space for receiving the stabilizer is not required. The packaging material is reduced, the inventory space is smaller, and the transport fees are cut.

2. The weight of the illuminating device is reduced, because the illuminating device has a smaller size and uses less material.

3. The manufacturing costs for the illuminating device are minimized due to fewer components and high manufacturing speed.

4. Installation of the illuminating device is simplified due to use of the snap fasteners allowing easy, rapid mounting and removal of the illuminating device.

5. The illuminating device provides optimal illumination, since the relative position between the mirror plate and the fluorescent tube can be arranged to provide the brightest illumination.

6. The service life of the shade is maximized, since the shade has no consumptive parts, and only replacement of the fluorescent tube and the stabilizer is required.

7. Simplified recycling is allowed due to fewer parts and easy sorting.

8. The stabilizer can be custom-made for the clients according to specifications and budgets. Only manufacturing of cheap snap fasteners of corresponding sizes is required.

9. Do-it-yourself (DIY) repair of the stabilizer is available. Mounting and removal of the snap fasteners are as easy and fast as replacement of starters.

10. Wiring of the stabilizer is simplified. A stabilizer can be utilized for up to ten illuminating devices. Only mounting of the stabilizer on one of the illuminating devices is sufficient. The other illuminating devices can be connected by internal wires, and a connector can be inserted into a connector seat of the stabilizer to accomplish wiring.

The primary objective of the present invention is to provide a continuous, one-piece illuminating deice that extends two or more sections of a light steel frame. After installation of a plurality of illuminating devices on the light steel frame, the spacing between two adjacent illuminating devices can be shortened to increase the illuminated area and to provide even brightness as well as increased brightness. Energy-saving, high-efficient fluorescent tube is utilized as the light tube to prolong the service life while reducing the electricity consumption and providing even, bright illumination.

Another objective of the present invention is to provide two types of installation of illuminating devices. In one type, the illuminating deice can be mounted on top of a light steel frame in a concealed manner, which is usually utilized in offices to provide a high cutoff angle, to prevent glaring light, and to avoid generation of shadows on a computer screen. In the other type, the illuminating device is mounted below a beam of a light steel frame, providing high-quality air conditioning, better illumination on displayed commodities, easy installation of the illuminating device, and anti-dust effect for the light tube. Thus, the user can select the desired type of installation of illuminating devices according to needs, providing wider applications of the illuminating devices for light steel frames. Furthermore, the illuminating device according to the preferred teachings of the present invention is one-piece and simple and presents a modern appearance, avoiding bulky sizes of conventional designs.

A further objective of the present invention is to provide two types of snap fasteners: one for mounting the stabilizer on a top side of the illuminating device without occupying the space inside the shade, the other for rapidly and removably mounting the illuminating device below the light steel frame. The installation is easy and simple, reducing the costs for installation. Thus, the snap fasteners allow easy installation of the illuminating devices according to different uses.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a conventional illuminating device mounted on a light steel frame.

FIG. 2 shows a perspective view of an illuminating device for a light steel frame according to the preferred teachings of the present invention.

FIG. 3 shows a partial, bottom, perspective view of the light steel frame and the illuminating device according to the preferred teachings of the present invention.

FIG, 4 shows a partial, cross sectional view of the light steel frame and the illuminating device according to the preferred teachings of the present invention.

FIG. 5 shows a partial, exploded, perspective view of the light steel frame and the illuminating device according to the preferred teachings of the present invention.

FIG. 6 shows a partial, cross sectional view illustrating another assembly of the light steel frame and the illuminating device according to the preferred teachings of the present invention.

FIG. 7 shows a top, perspective view of a light steel frame and a plurality of illuminating devices according to the preferred teachings of the present invention mounted to the light steel frame.

FIG. 8 shows a perspective view of a snap fastener for fixing an electronic stabilizer of the illuminating device according to the preferred teachings of the present invention.

FIG. 9 shows a perspective view illustrating mounting of the illuminating device according to the preferred teachings of the present invention to a longitudinal beam of a grid of the light steel frame.

FIG. 10 shows a perspective view of the illuminating device according to the preferred teachings of the present invention and the light steel frame of FIG. 9 with the light steel frame shown in phantom lines.

FIG. 11 shows a perspective view of the illuminating device according to the preferred teachings mounted below the light steel frame.

FIG. 12 shows a perspective view of a snap fastener for fixing the illuminating device according to the preferred teachings of the present invention to the light steel frame.

FIG. 13 shows a cross sectional view of the illuminating device according to the preferred teachings of the present invention mounted below the light steel frame.

FIG. 14 shows a cross sectional view of an illuminating device of a modified embodiment according to the preferred teachings of the present invention mounted below a light steel frame.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

With reference to the drawings, an illuminating device 2 according to the preferred teachings of the present invention is generally mounted on a light steel frame 1 fixed to a ceiling. More particularly, the illuminating device 2 can be mounted across two or more sections of the light steel frame 1. The illuminating device 2 includes at least one elongated shade 21, an electronic stabilizer 22, a durable, energy-saving fluorescent tube 23, and first and second snap fasteners 24 and 25. An end cap 215 is mounted to each of two ends of the shade 21 and includes a light seat 219. The light seats 219 are aligned with each other. A bowl-shaped mirror reflector 216 is mounted in the shade 21 for concentrating and reflecting light beams and for avoiding accumulation of dust. The shade 21 is substantially bowl-shaped in cross section. The fluorescent tube 23 is mounted in the shade 21 and has an appropriate length (such as 2.4 m) corresponding to a length of a section of the light steel frame 1, providing continuous, long-distance spatial illumination. The stabilizer 22 is external to and initially separate from the shade 21. High-quality electronic stabilizer 22 generally has a larger size. Separate arrangement of the stabilizer 22 enhances the reflective efficiency while reducing the size of the illuminating device 2. Furthermore, an electronic stabilizer 23 can be utilized with more than one illuminating devices according to the teachings of the present invention. Only mounting of the electronic stabilizer 22 on one of the illuminating devices 2 is sufficient. The other illuminating devices 2 can be connected by internal wires, and a connector can be inserted into a connector seat of the stabilizer to accomplish wiring, which is faster and simpler than illuminating devices with stabilizers initially fixed to the illuminating devices. High-frequency activation of the electronic stabilizer 22 provides a stable light source and avoids flickering while prolonging the service life of the fluorescent tube 23. The fluorescent tube 23 (such as T5 fluorescent tube) provides a durable, energy-saving light source by providing higher light flux, higher lighting efficiency, and less energy consumption. The brightness provided by the fluorescent tube 23 is higher than conventional fluorescent tubes. As an example, comparing a T5/28 W fluorescent tube 23 of 2.4 m with a conventional T8/40 W fluorescent tube of the same length, the T5 fluorescent tube 23 provides the same brightness but saves 30% of electricity. The illuminated area is larger, and the brightness is even and increased. Thus, the illuminating device 2 according to the teachings of the present invention is suitable to the heights of current offices or convenience stores without side-by-side arrangement of the illuminating devices 2.

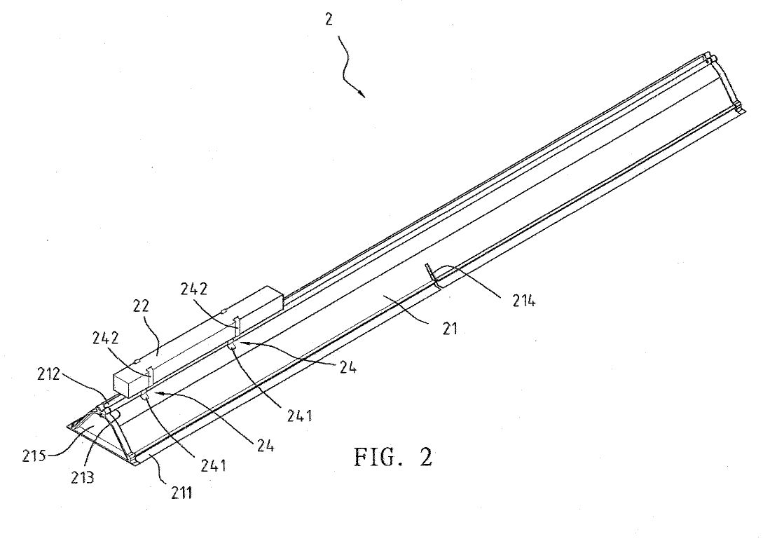

With reference to FIGS. 2-4, the shade 21 of the illuminating device 2 according to the preferred teachings of the present invention is formed by extrusion or calendaring molding. A wing 211 extends horizontally from each of two lateral sides of the shade 21. An extrusion ridge 212 is formed on a top side of the shade 21 and includes two lateral walls each having a groove 213. Furthermore, the shade 21 includes a slot 214 in an intermediate portion thereof. The slot 214 receives a transverse beam 12 crossed by the shade 21. Thus, the shade 21 can extend across two sections of the light steel frame 1 spaced by the transverse beam 12. It can be appreciated that the shade 21 can extend across more than two sections of the light steel frame 1.

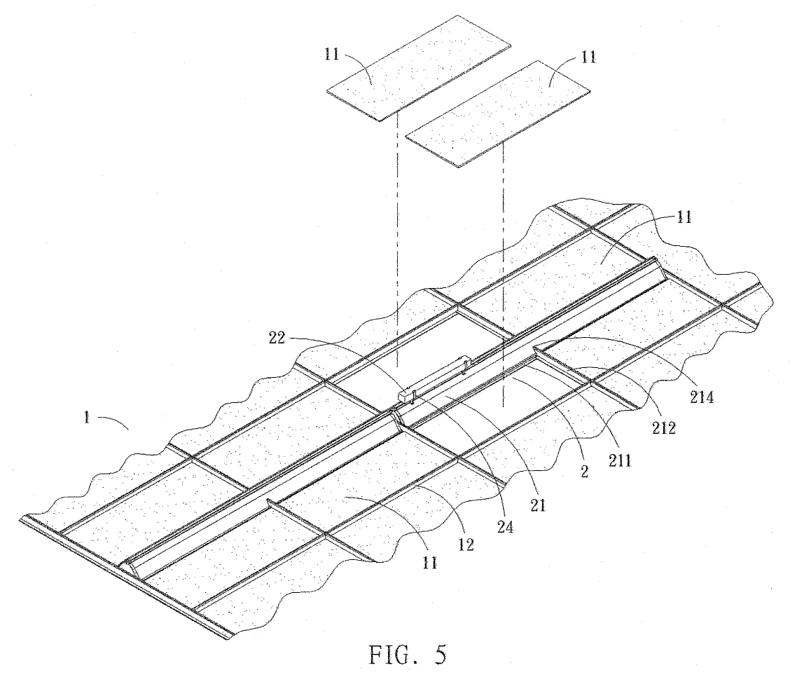

When the illuminating device 2 is mounted on top of the light steel frame 1 in a concealed manner (FIGS. 4 and 5), since the illuminating device 2 extends across two or more sections of the light steel frame 1 and is located in a middle portion of each section, two shield boards 11 (such as calcium silicate boards) can be cut to an appropriate area and placed between the wings 211 of the illuminating device 2 and two longitudinal beams 12 of the light steel frame 1. An edge of each shield board 11 rests on one of the wings 211. Thus, the aesthetic appearance of the light steel frame 1 is not adversely affected.

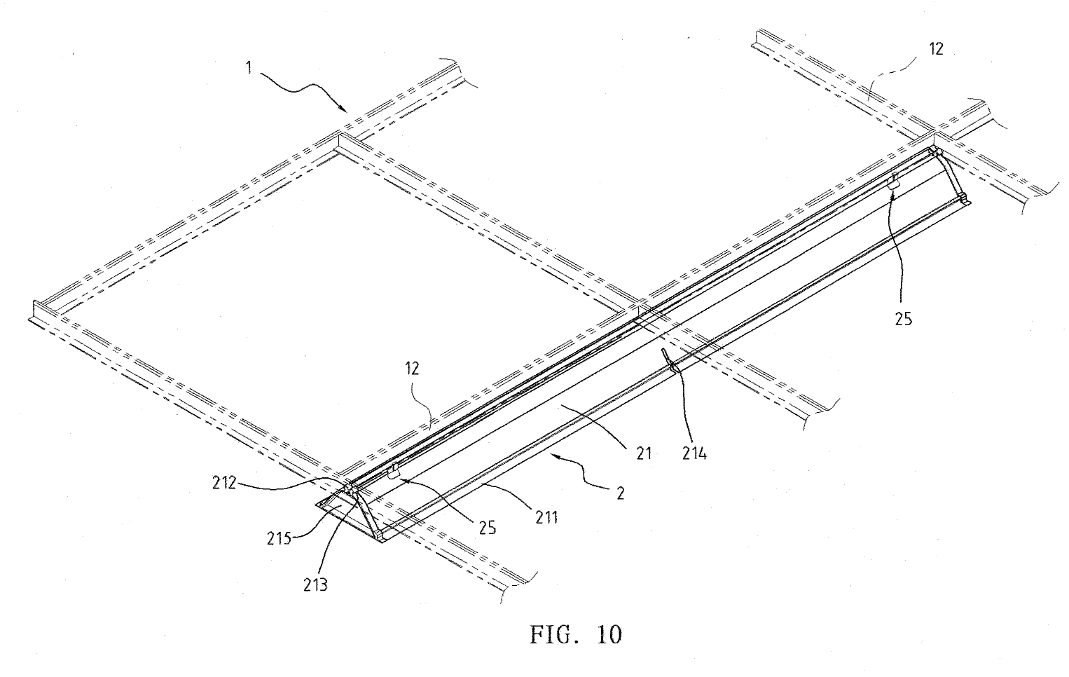

With reference to FIGS. 2 and 10, the extrusion ridge 212 on the top side of the shade 21 provides several functions. The grooves 213 in the lateral walls of the extrusion ridge 212 can be utilized with the first snap fasteners 24 or the second snap fasteners 25 to fix the electronic stabilizer 22 on the illuminating device 2 or to mount the illuminating device 2 below the beams 12 of the light steel frame 1. The structure and installation of each of the first and second snap fasteners 24 and 25 will be discussed in detail hereinafter.

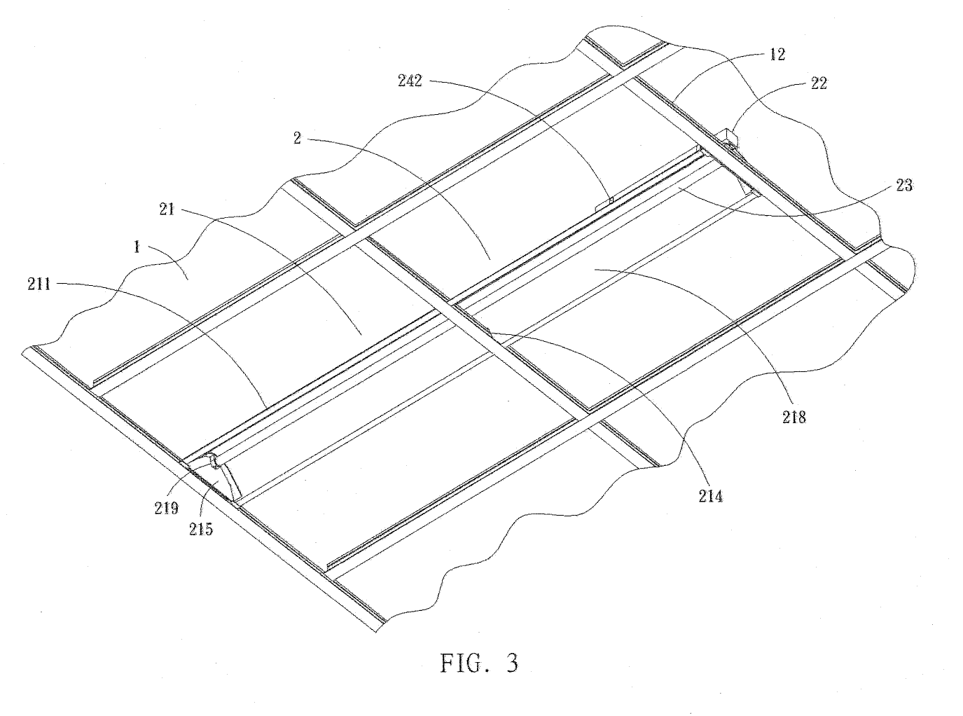

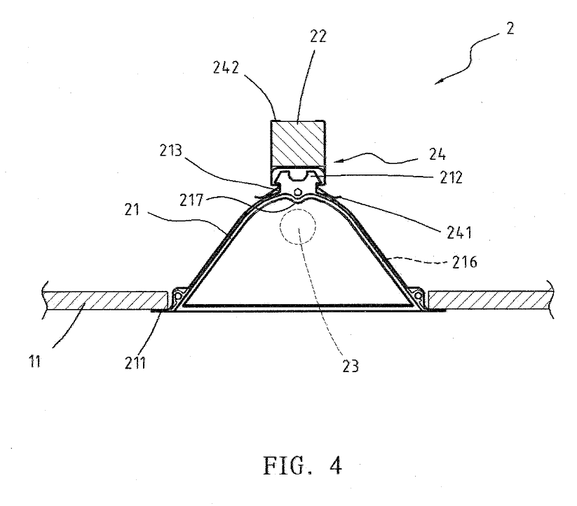

With reference to FIGS. 2 and 3, when the illuminating device 2 is mounted on top of the light steel frame 1 and extends across two or more sections of the light steel frame 1, the slot 214 in the intermediate portion of the shade 21 receives the transverse beam 12 without adversely affecting extension of the shade 21 across two or more sections of the light steel frame 1. Alternatively, the shade 21 does not have to include the slot 214. In this case, each transverse beam 12 can be cut at an intersection with the shade 21 to form a cutout having a width slightly smaller than the shade 21. The intersection includes two edges on opposite sides of the cutout. The two edges rest on and are supported by the wings 211 of the shade 21 while allowing the illuminating device 2 to extend across two or more sections of the light steel frame 1.

The illuminating device 2 according to the preferred teachings of the present invention can be mounted in two ways utilizing the first or second snap fasteners 24, 25.

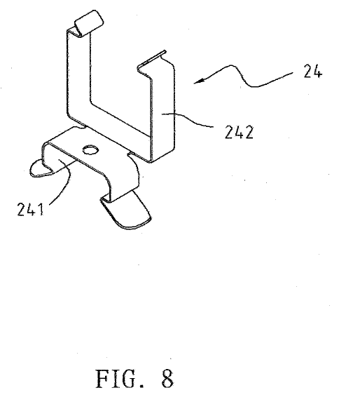

When the illuminating device 2 is mounted on top of the light steel frame 1, the first snap fastener 24 is utilized to mount the electronic stabilizer 22 on the shade 21. With reference to FIGS. 4, 7, and 8, the first snap fastener 24 includes a substantially inverted U-shaped lower clip 241 having two sides each with an inwardly protruded portion. The inwardly protruded portions of the sides of the lower clip 241 of the first snap fastener 24 is engaged in the grooves 213 of the lateral walls of the extrusion ridge 212. The first snap fastener 24 further includes a substantially U-shaped upper clip 242 having two sides each with an inwardly protruded portion. The inwardly protruded portions of the sides of the upper clip 242 of the first snap fastener 24 clamp two upper, lateral edges of the electronic stabilizer 22. This allows the electronic stabilizer 22 to be mounted to the shade 21 while the illuminating device 2 is mounted on top of the light steel frame 1 (see FIGS. 2, 4, and 7).

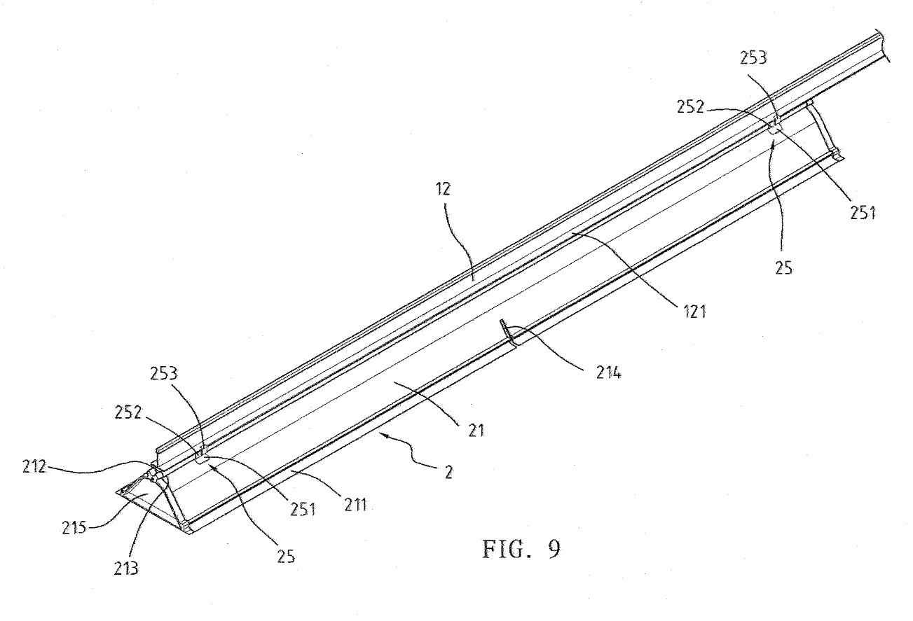

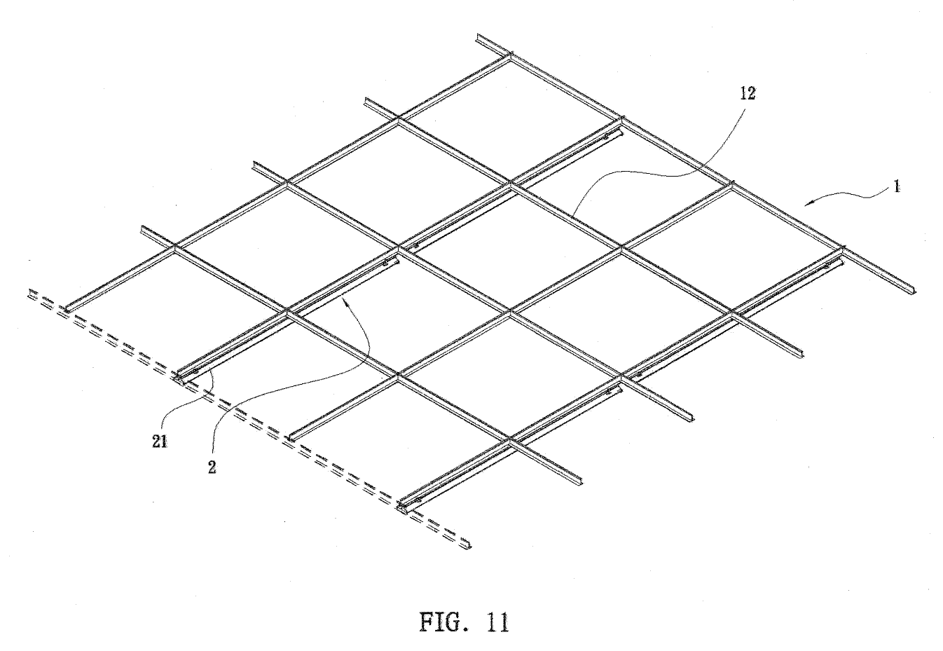

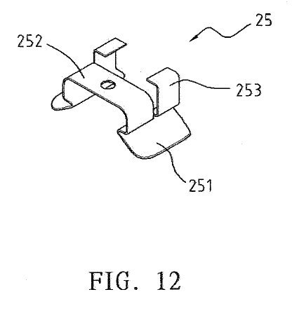

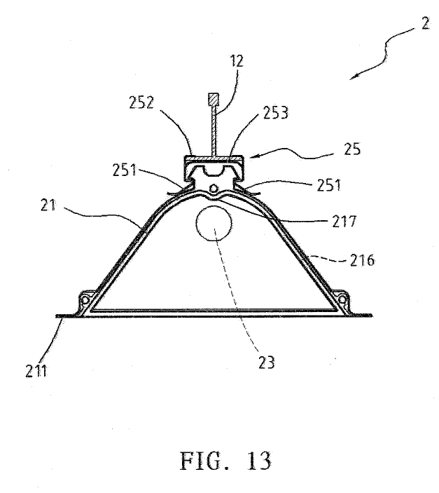

On the other hand, when the illuminating device 2 is mounted below the light steel frame 1, the second snap fastener 25 is utilized. With reference to FIGS. 9, 11, and 12, the second snap fastener 25 includes a lower clip 251 having two sides each with an inwardly protruded portion. The inwardly protruded portions of the sides of the lower clip 251 of the second snap fastener 25 are engaged in the grooves 213 of the lateral walls of the extrusion ridge 212. The second snap fastener 25 further includes a substantially inverted U-shaped section 252. The lower clip 251 and the section 252 of the second snap fastener 25 receive the extrusion ridge 212 of the shade 21 (see FIGS. 9 and 13). The second snap fastener 25 further includes a substantially U-shaped upper clip 253 extending higher than the section 252. The longitudinal beam 12 of the light steel frame 1 is substantially inverted T-shaped in cross section and has two lateral edges 121. The upper clip 253 includes two arms each having an inwardly extending hook clamping one of the two lateral edges 121 of the inverted T-shaped longitudinal beam 12. Since the illuminating device 2 according to the preferred teachings of the present invention is one-piece, the illuminating device 2 can be quickly mounted to any desired location below the light steel frame 1 using one or more second snap fasteners 25 without using any tool. In installation, the fluorescent tube 23 is firstly mounted into the shade 21, and the extrusion ridge 212 of the shade 2 is pushed into the second snap fasteners 25 to mount the illuminating device 2 below the light steel frame 1. Detachment of the illuminating device 2 can be easily accomplished by pushing either side of each second snap fastener 25. The wiring between the illuminating device 2 and the electronic stabilizer 22 can be achieved by a quick-coupling type connector to reduce the costs for installation.

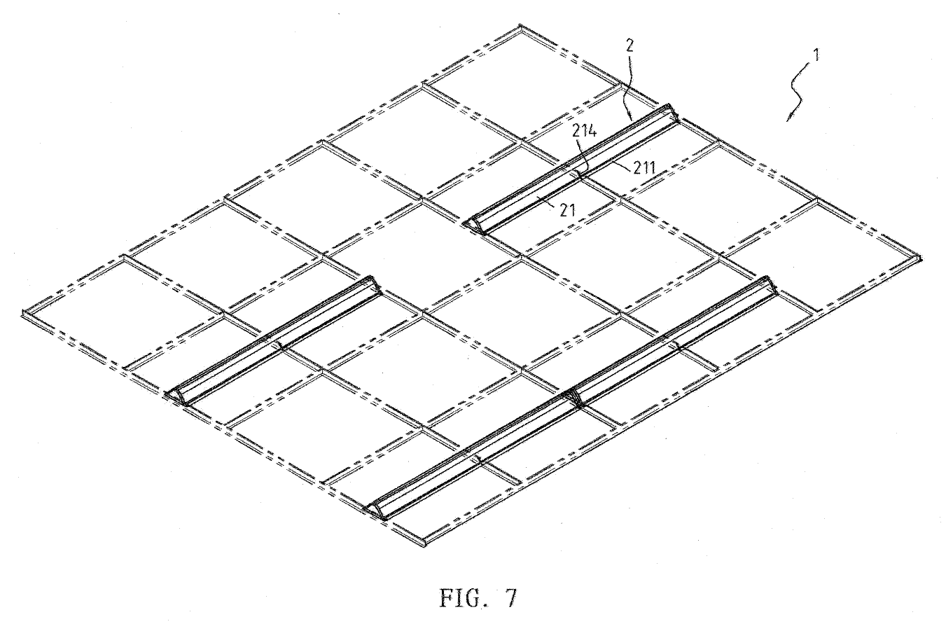

Thus, the present invention provides a multiple-use illuminating device 2. Namely, the illuminating device 2 can be mounted on top of the light steel frame 1 in a concealed manner (see FIGS. 5 and 7) and extend across two or more beams 12 of the light steel frame 1. Furthermore, two or more illuminating devices 2 can be connected in series or spaced in a short distance in a lateral direction. The illuminated space can be larger, and the brightness is even. Furthermore, high brightness is provided and consumes less energy by utilizing energy-saving, high-brightness fluorescent tube 23. The illuminating device 2 mounted on top of the light steel frame 1 is suitable for offices to provide a high cutoff angle, to prevent glaring light, and to avoid generation of shadows on a computer screen, avoiding discomfort in the eyes or bodies of the workers in the offices. On the other hand, the illuminating device 2 according to the teachings of the present invention can be mounted to the beams 12 and below the light steel frame 1 by the second snap fasteners 25. Similar to the first type of installation, two or more illuminating devices 2 can be connected in series or spaced in a short distance in the lateral direction to provide a larger illuminated space as well as even brightness. Better illumination on displayed commodities is, thus, provided under higher brightness while providing anti-dust effect as well as energy-saving function.

Examples of use of the illuminating device 2 according to the teachings of the present invention in comparison to conventional illuminating devise for light steel frame will now be described.

In a conventional arrangement, light box type illuminating devices each including four 20 W light tubes (total power 80 W) were spaced by 4.8 m (1.2 m×4 sections). In an arrangement according to the teachings of the present invention, two 40 W light tubes (total power 80 W) were mounted consecutively (2.4 m×2=4.8 m). The following advantages were obtained by the arrangement according to the teachings of the present invention:

1. The brightness in the area having a length of 4.8 m was even, while the brightness provided by the conventional arrangement was extremely uneven.

2. The brightness provided by a T8/40 W light tube was the same as three T8/20 W light tube. Thus, the total brightness of the arrangement according to the teachings of the present invention was increased by ⅓.

3. The service life of a T8/40 W light tube was approximately the same as two T8/20 W light tubes. Thus, the light tube of the arrangement according to the teachings of the present invention was double of the conventional arrangement,

In a case that the T8/40 W light tubes were replaced with high-power T5/28 W light tubes having substantially the same length, the brightness was substantially the same while the electricity consumed could be saved more than 30%. In another case that the T8/40 W light tubes were replaced with high-output T5/54 W light tubes having the same length (the same shade 21 could be utilized, but a matching stabilizer must be used), both the electricity consumed and the brightness were doubled, suitable for spaces requiring high brightness without increasing the number of the illuminating devices.

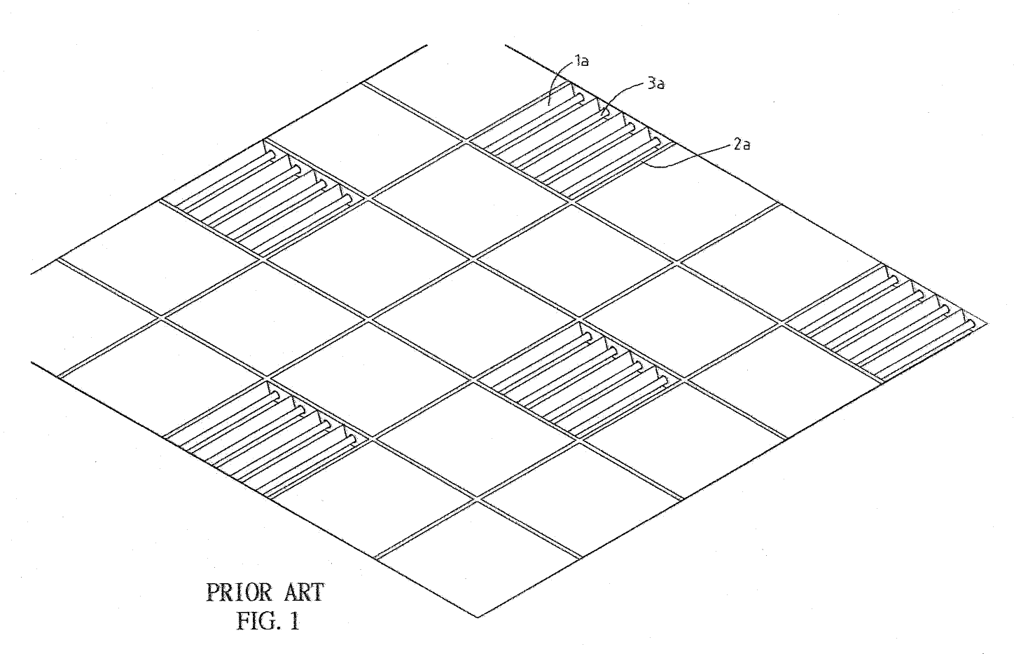

In another example, the illuminating devices 2 can be connected in series to form a long, consecutive illuminating arrangement. With reference to FIGS. 1 and 5, in a case that two illuminating devices 2 were connected in series, a T5/28 W light tube was mounted in each shade 21 (the total power is 56 W). The brightness in the illuminated area with a length of 4.8 m was even. In comparison to an insert type light box 1a having four T8/20 W light tubes in a 1.2 m×1.2 m area, the brightness of the arrangement according to the teachings of the present invention was increased by about ⅓, and the electricity consumed was reduced by 30%.

Another objective of the present invention is to improve the anti-dust effect and to increase the reflective efficiency of the light source. The anti-dust effect is achieved by avoiding adherence of dust in the air to the upper half of the fluorescent tube 23, preventing adverse affect to the output of the light beams from the fluorescent tube 23. With reference to FIGS. 2-4, the fluorescent tube 23 is mounted adjacent to (or in contact with) the pointed portion 217 of the bowl-shaped mirror reflector 216. Furthermore, the shade 21 defines a semi-sealed space having a lower opening 218 by using the end caps 215. Thus, the outer side of the top portion of the shade 21 avoids adherence of dust to fluorescent tube 23 (i.e., the outer side of the top portion of the shade 21 avoid dust from falling from above onto the upper half of the fluorescent tube 23). Furthermore, due to provision of the first snap fasteners 24, the illuminating device 2 can be mounted to any desired location, and the electronic stabilizer 22 can be fixed to any desired location on the extrusion ridge 212. Thus, except for the lower opening 218, the shade 21 has no holes for fixing purposes. As a result, convection between the air in the semi-sealed space and the upward air current outside of the shade 21 will not when there is no wind, even if the lower opening 218 of the shade 21 is not covered by a transparent cover, preventing dust from entering the semi-sealed space from below. The amount of dust entering the semi-sealed space of the shade 21 from below can be reduced even if there is a breeze. Thus, the dustfall on the upper half of the fluorescent tube 23 can be significantly reduced, keeping clean and, maintaining output of the fluorescent tube 23.

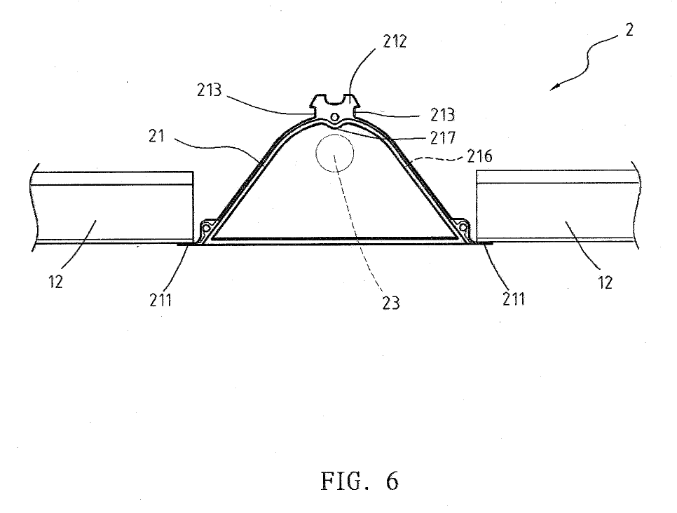

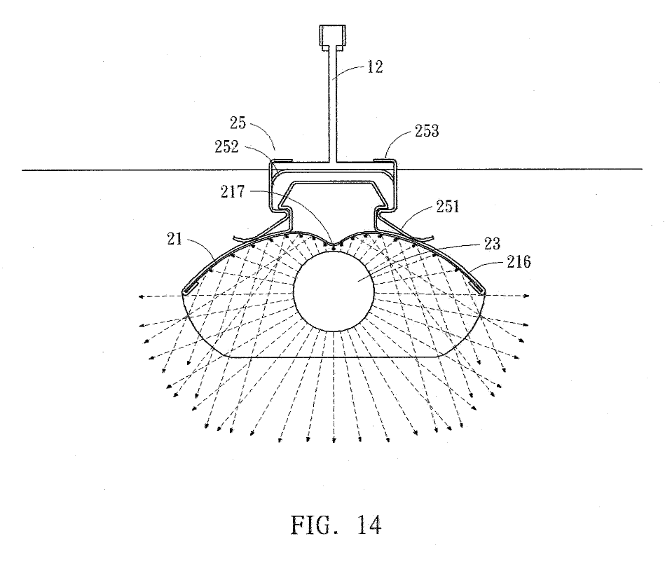

Increase of the reflective efficiency of the light source will now be described. With reference to FIGS. 6 and 13, since the fluorescent tube 23 mounted in the shade 21 is adjacent to the mirror reflector 216, the light beams emitted from the upper half of the fluorescent tube 23 are reflected out of the shade 21 by the mirror reflector 216, increasing the brightness by more than 50%, Furthermore, the fluorescent tube 23 adjacent to the mirror reflector 216 can block air currents at two sides of the mirror reflector 216, reducing the possibility of adherence of dust and further enhancing the anti-rust effect. To further enhance the anti-dust effect and the reflective efficiency of the light source, the fluorescent tube 23 can be more adjacent to or even in contact with the pointed portion 217 of the mirror reflector 216. Furthermore, the illuminating device 2 according to the teachings of the present invention can provide wide-area illumination suitable for supermarkets or shopping malls. Light beams emitted upward towards the ceiling in conventional arrangements can be reflected downwards in the arrangement according to the teachings of the present invention while reducing glaring light and dustfall on the light tube. With reference to FIG. 14 showing the shade 21 of the illuminating device 2 mounted below the light steel frame 1 in a roof-mounted manner, the shade 21 includes an arcuate extension extending outward from each of two sides of the bowl-shaped section of the shade 21. Note that the mirror reflector 216 is also bowl-shaped. By such an arrangement, the lower half of the fluorescent tube 23 is exposed outside of the shade 21. It is further noted that the fluorescent tube 23 is adjacent to the bowl-shaped mirror reflector 216. Thus, the light beams emitted upwards from the upper half of the fluorescent tube 23 can be reflected downwards to provide enhanced illuminating effect for the displayed commodities while reducing glaring light and dustfall on the fluorescent tube 23. The illuminating quality in the shopping malls is enhanced while effectively displaying the commodities.

By the arrangement of the present invention, the illuminating device 2 mounted on the light steel frame 1 can provide brighter, even illumination while saving electricity, solving the problems of electricity consumption and insufficient, uneven brightness encountered by the prior art.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An illuminating device for a light steel frame comprising:
at least one one-piece elongated shade including two ends each having an end cap mounted thereto, with said at least one elongated shade defining an opening and being bowl-shaped in cross section, with each of the end caps including a light seat, with the light seats aligned with each other, with said at least one shade including a bowl-shaped mirror reflector mounted therein, with said at least one elongated shade being formed by extrusion or calendaring molding, with said at least one elongated shade including two lateral sides and a top side, with a wing extending horizontally from each of the two lateral sides of said at least one elongated shade, with an extrusion ridge formed on the top side of said at least one elongated shade, with the extrusion ridge including two lateral walls each having a groove, with two shield boards adapted to be mounted in each of the sections of the light steel frame extended across by said at least one elongated shade, with each of the two shield boards having an edge resting on one of the wings of said at least one elongated shade;
an electronic stabilizer;
a durable, energy-saving fluorescent tube mounted in each of said at least one elongated shade, with the fluorescent tube longer than one of a plurality of sections of the light steel frame to provide continuous, long-distance spatial illumination; and
first and second snap fasteners selectively engaged with the grooves of the extrusion ridge, with the first snap fastener fixing the electronic stabilizer on the extrusion ridge, with the second snap fastener adapted to fix the illuminating device to a longitudinal beam of the light steel frame.

2. The illuminating device as claimed in claim 1, with said at least one elongated shade including a slot in an intermediate portion thereof, with the slot receiving a transverse beam crossed by said at least one elongated shade so that said at least one elongated shade extends across two of the sections of the light steel shade spaced by the transverse beam.

3. The illuminating device as claimed in claim 1, with the beam being cut at an intersection with said at least one elongated shade to form a cutout having a width slightly smaller than said at least one elongated shade, with the intersection including two edges on opposite sides of the cutout and respectively resting on the wings of said at least one elongated shade, allowing the illuminating device to extend across two sections of the light steel frame.

4. The illuminating device as claimed in claim 1, with the electronic stabilizer being an external type electronic stabilizer.

5. The illuminating device as claimed in claim 1, with the first snap fastener including a substantially inverted U-shaped lower clip having two sides each with an inwardly protruded portion, with the inwardly protruded portions of the two sides of the lower clip of the first snap fastener engaged in the grooves of the lateral walls of the extrusion ridge, with the first snap fastener further including a substantially U-shaped upper clip having two sides each with an inwardly protruded portion, with the inwardly protruded portions of the two sides of the upper clip of the first snap fastener clamping two upper, lateral edges of the electronic stabilizer.

6. The illuminating device as claimed in claim 1, with the second snap fastener including a lower clip having two sides each with an inwardly protruded portion, with the inwardly protruded portions of the two sides of the lower clip of the second snap fastener engaged in the grooves of the lateral walls of the extrusion ridge, with the second snap fastener further including a substantially inverted U-shaped section, with the lower clip and the section of the second snap fastener receiving the extrusion ridge of said at least one elongated shade, with the second snap fastener further including a substantially U-shaped upper clip extending higher than the section of the second snap fastener, with the longitudinal beam of the light steel frame being substantially inverted T-shaped and having two lateral edges, with the upper clip including two arms each having an inwardly extending hook clamping one of the two lateral edges of the inverted T-shaped beam.

7. The illuminating device as claimed in claim 1, with said at least one elongated shade mounted below the light steel frame, with said at least one elongated shade further including an arcuate extension extending outward from each of two sides of the bowl-shaped section of said at least one elongated shade, with a lower half of the fluorescent tube exposed outside of said at least one elongated shade.

8. The illuminating device as claimed in claim 1, with the bowl-shaped mirror reflector including a pointed portion, with the fluorescent tube mounted adjacent to the pointed portion.
